(19) United States
(12) Patent Application Publication
(10) Pub. No.: US 2011/0258560 A1
(43) Pub. Date: Oct. 20, 2011

(54) AUTOMATIC GATHERING AND DISTRIBUTION OF TESTIMONIAL CONTENT

(75) Inventors: Marc E. Mercuri, Bothell, WA (US); Martha T. Collins, Seattle, WA (US)

(73) Assignee: Microsoft Corporation, Redmond, WA (US)

(21) Appl. No.: 12/759,712

(22) Filed: Apr. 14, 2010

(51) Int. Cl. G06F 15/16; G06F 3/01

(52) U.S. Cl. 715/753; 709/204

(57) ABSTRACT

A testimonial promotion system is described herein that automatically identifies content that has a positive sentiment for a topic that an organization cares about and includes identified content in a promotional location for the organization. The system provides a mechanism by which to view, filter, moderate, classify, and re-publish this content from multiple social media sites into a feed that can be consumed on first and third party websites. The system automatically pre-filters content based on base criteria, and then optionally queues the content for review by human moderators. After moderation, the system aggregates content from all sites into one or more feeds and publishes the feeds for consumption by one or more sites. The system spreads positive messages about the organization to a wider audience and allows consumers considering the organization's products or services to have awareness of past positive experiences with the organization that the consumers might not otherwise discover.

### BACKGROUND

An organization's reputation may be one of the most valuable assets that the organization possesses. For example, a company's sales may be determined (in part) by how well customers trust the company to deliver products of a high quality and on time to the customer. Many customers determine whether they will deal with a particular business by how a customer service department of the business will handle things that go wrong (e.g., a missing shipment, damaged goods, and so on). Many organizations have built substantial reputations around the quality of their customer service and others have suffered due to negative impressions of their customer service.

Internet forums and other online gathering places are increasingly becoming places where brands are discussed and where an organization's reputation can be affected by “word-of-mouth” communications of which the organization may not even be aware. Numerous forums exist where reviews can be posted and where users can discuss experiences with particular companies. Ratings agencies may rate a company based on such discussions. Some users have even created web sites with the specific purpose of discussing good or bad experiences with a particular company. For example, many sites are named “I Hate Company X” where Company X is a company that the user does not like and/or with which the user has had a negative experience. Conversely, uses that have had positive experiences with a company often create fan sites that promote a positive brand image of the company.

Testimonials are a common form of explaining to new consumers the value that a product has held for past consumers. It is often said that there is no better advertisement than the opinions of real people. The growing number of social networks and the faster growing number of individuals contributing content to them is a fertile environment full of these opinions. There is significant value in capturing the opinions and conversations about a brand and re-publishing them as real-time/near real-time customer testimonials on first and third party sites. However, this information changes rapidly and finding and using the information is a tedious manual process that generally involves hiring workers to go and find positive content and re-post it or link to it on a corporate website.

### SUMMARY

A testimonial promotion system is described herein that automatically identifies content that has a positive sentiment for an organization and includes identified content in a promotional location for the organization. The system provides a mechanism by which to view, filter, moderate, classify, and re-publish this content from multiple social media sites into a feed that can be consumed on first and third party websites. The system automatically pre-filters content based on base criteria, and then optionally queues the content for review by human moderators. After moderation, the system aggregates content from all sites into one or more feeds and publishes the feeds for consumption by one or more sites. The system can gather content from a variety of sources, such as blogs, social media sites, comments, product reviews, search engines, and so forth. Thus, the testimonial promotion system spreads positive messages about the organization to a wider audience and allows consumers considering the organization's products or services to have awareness of past positive experiences with the organization that the consumers might not otherwise discover.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the testimonial promotion system, in one embodiment.

FIG. 2 is a flow diagram that illustrates processing of the testimonial promotion system to automatically publish relevant content, in one embodiment.

FIG. 3 is a flow diagram that illustrates processing of the organization promotion to moderate retrieved content, in one embodiment.

FIG. 4 is a display diagram that includes a display page that illustrates a page fed with data from the testimonial promotion system, in one embodiment.

### DETAILED DESCRIPTION

A testimonial promotion system is described herein that automatically identifies web-based content that has associated sentiment for an organization and includes identified content in a promotional location for the organization. The system provides a mechanism by which to view, filter, moderate, classify, and re-publish this content from multiple social media sites into a feed that can be consumed on first and third party websites. The system automatically pre-filters content based on base criteria (e.g., sentiment, profanity), and then optionally queues the content for review by human moderators. After moderation, the system aggregates content from all sites into one or more feeds and publishes the feeds for consumption by one or more sites. For example, the system may provide a Really Simply Syndication (RSS) feed for each product that an organization sells or manufacturers. The system can gather content from a variety of sources, such as blogs, social media sites (e.g., Facebook and Twitter), comments, product reviews, search engines, and so forth. For example, the system can use a spider or other crawling software to identify content or direct requests to a search engine that has already crawled and indexed content.

Upon identifying content that is potentially relevant to the organization (e.g., by keywords or semantic information), the system places the content in a queue that is part of a workflow for reviewing the content and re-publishing it to one or more content consumers. The system may perform one or more levels of automated and/or manual review that ensure that the content is free of offensive material (e.g., profanity or pornography), and that the sentiment of the content meets the criteria for the organization (e.g., the system may identify negative keywords or a sarcastic tone of the content to automatically reject content based on negative sentiment). In some embodiments, the system performs one or more levels of automated review before involving a human moderator for a final step of manual review. After the content has been approved either automatically or manually, the system provides the content to one or more content consumers for republishing as an organization testimonial. Thus, the testimonial promotion system spreads positive messages about the organization to a wider audience and allows consumers considering the organization's products or services to have awareness of past positive experiences with the organization that the consumers might not otherwise discover.

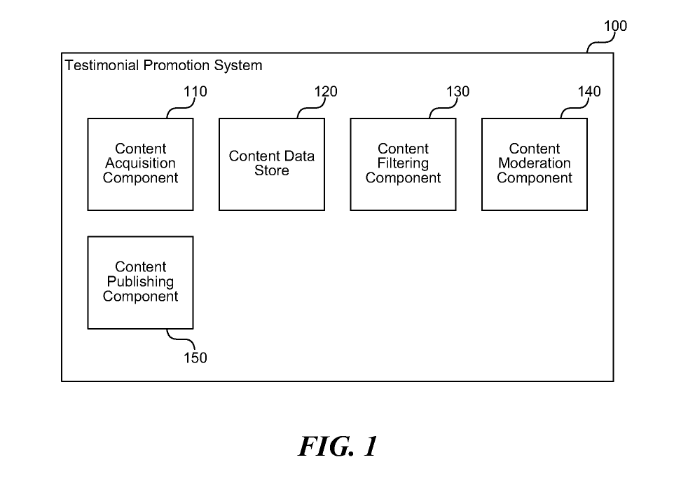

FIG. 1 is a block diagram that illustrates components of the testimonial promotion system, in one embodiment. The system 100 includes a content acquisition component 110, a content data store 120, a content filtering component 130, a content moderation component 140, and a content publishing component 150. Each of these components is described in further detail herein.

The content acquisition component 110 searches a network for one or more content sources and identifies content potentially related to an organization. For example, the content acquisition component 110 may interface with search engines, blog hosts, or other sources of content to identify content that mentions or relates to the organization or the organization's products or services. The component 110 stores information about identified content in the content data store 120. The stored information may include a link to the original content, a local copy of the content, a date the content was acquired, a user associated with the content, the source of the content, and a state of the content (e.g., retrieved, filtered, moderated, and so forth). The content acquisition component 110 may identify many types of content including text (e.g., blog posts or product reviews), videos, ratings, and so forth.

The content data store 120 stores identified content for further review and potential re-publishing. The content data store 120 may include one or more hard drives, file systems, databases, storage area networks (SANs), cloud-based storage services, or any other technique for persisting data so that it can be later retrieved and analyzed. For example, the content acquisition component 110 may add a row in a database table for each identified content item, and other components access the rows to determine which content items to re-publish or make available in feeds.

The content filtering component 130 automatically reviews and filters identified content to eliminate content that does not satisfy publishing criteria. For example, the component 130 may employ keyword or other filters to eliminate content items that include profanity, negative sentiment, reviews from particular sources, and so forth. The component 130 may also filter or categorize content by its substance, such as a language of the content (e.g., so that a separate feed can be displayed for each language), products to which the content relates, a type of the content, and so forth. The content filtering component 130 makes an automated first pass to attempt to eliminate content that is not related to testimonials or positive reviews of a product or service. In some embodiments, the system 100 may directly publish content after the first level of review provided by the content filtering component 130.

Alternatively or additionally, the system 100 may employ human moderation to double check the automated filtering of the component 130. In some embodiments, results of human moderation are used to provide a feedback loop that improves automated moderation over time. For example, if a human moderator determines that a content item let through by automated filtering contains new offensive words or topic material not suitable for republishing, the human moderator may add new words to a keyword blacklist of the content filtering component 130 or the system may automatically identify similarities between content items rejected by human moderators and update filters of the content filtering component 130 to catch and filter similar future content items.

The content moderation component 140 receives indications from human moderators that indicate whether particular content items are suitable for publishing or not. Moderators may evaluate the content, apply additional metadata tags, and make a determination on whether to publish the content. In some embodiments, the system 100 may publish content after automated review by the content filtering component 130 to allow fast update of positive user sentiment about a product and then allow later moderation to lazily pull down content that is determined to be unsuitable or less targeted to a promotion stream provided by the system 100. Alternatively or additionally content may wait in a queue for human moderation and only be published after explicit approval. Human moderators may flag content items with additional tags such as products for which the content items are relevant, adding emphasis (e.g., bold text or flashing background) to particularly positive reviews, and so forth.

The content publishing component 150 provides one or more streams of content items that satisfy publishing criteria and moderation and promote products or services of the organization. The component 150 places content to be published on a queue, such as within the content data store 120. At configurable intervals, the component 150 reads the queues and creates aggregate feeds that include one or more content items. These feeds are placed in the local file system or other data storage, where the content publishing component automatically transfers them to a public facing site (e.g., a website or Content Delivery Network (CDN)) for consumption on first and third party sites. Generated feeds may include a source of the content, links to the content on the source site, Uniform Resource Locators (URLs) for a thumbnail image for the content, an author name, an author avatar URL, and so forth that allow for effective visualization of the content. The regularly updating feeds provide a highly responsive and up to date view of current conversations about a brand or subject, showing site visitors social media content, including micro-blog entries, blog entries, images, videos, and social network activity stream postings that relate to an organization's products or services.

The computing device on which the testimonial promotion system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

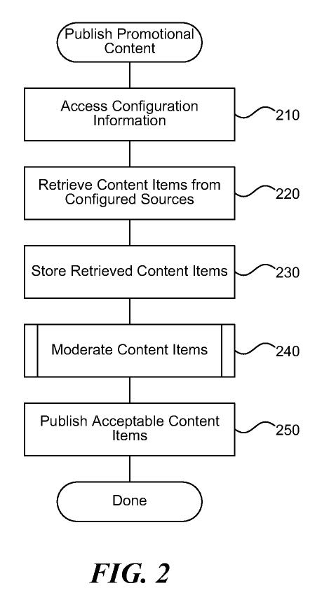

FIG. 2 is a flow diagram that illustrates processing of the testimonial promotion system to automatically publish relevant content, in one embodiment. Beginning in block 210, the system accesses configuration information that identifies one or more content sources from which to retrieve content items. For example, an administrator may select one or more sources from which to retrieve content items, such as blogs, RSS feeds, search engines, social networks, and so forth. The system may provide an administrative interface through which an administrator can configure sources. Alternatively or additionally, the system may also receive content sources from users, such as a suggestion submitted by a user.

Continuing in block 220, the system retrieves content items from the configured content sources. The content items may include blog posts, twitter tweets, comments, product reviews, and so forth. The system may retrieve the content items using common protocols such as Hypertext Transfer Protocol (HTTP) or other protocols applicable to particular content sources. Continuing in block 230, the system stores one or more retrieved content items in a data store. The system may also store metadata about the content items, such as a location from which each item was retrieved, a thumbnail of the content item, a link to the original content item, and so forth. The data store may include a local or remote data store accessible to the system, from which the system can later access the content items for moderation and publishing.

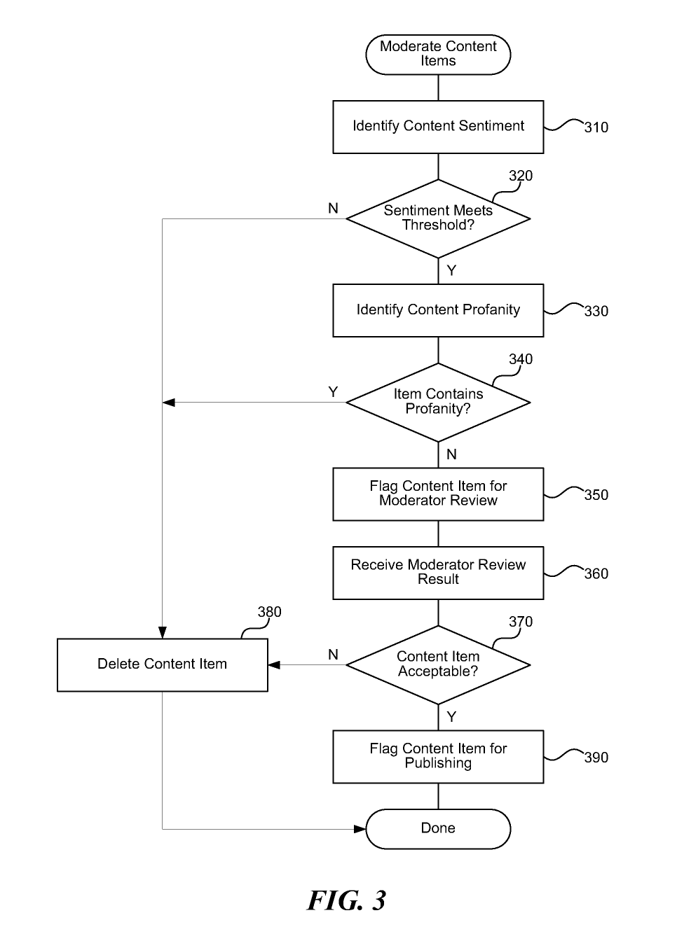

Continuing in block 240, the system moderates the retrieved content items to filter out content items that do not meet publishing criteria. The publishing criteria may include automated filtering rules, such as excluding profanity, excluding negative content items, excluding content items based on length, as well as manual moderation processes, such as receiving one or more human opinions about the content item. The system may provide an interface through which moderators can access content items and determine whether the content items will be published. Those of ordinary skill in the art will recognize that many potentially applicable moderation models exist, such as paid moderators, user community moderators, crowd-sourced moderation, and so forth. Content moderation is described in further detail with reference to FIG. 3.

Continuing in block 250, the system publishes content items that satisfy the publishing criteria. The system may publish content items by creating a feed, such as an RSS feed, or by providing a stream of content items, such as through an HTTP POST to a configured location or other method of transferring data. The system may publish content items on a predetermined regular schedule (e.g., every 5 minutes) and include any content items retrieved or accepted through moderation since the last interval. After block 250, these steps conclude.

FIG. 3 is a flow diagram that illustrates processing of the organization promotion to moderate retrieved content, in one embodiment. Beginning in block 310, the system identifies content sentiment that indicates a tone and purpose of a content item. For example, the system may identify keywords that indicate positive or negative sentiment. For example, keywords such as “like, love, and awesome” may indicate positive sentiment, whereas keywords such as “hate, frustrating, and broken” may indicate negative sentiment. The system may also use additional natural language processing techniques known in the art to process incoming content items to assess a meaning of the content items and whether the content items are likely to be received favorably by consumers. Continuing in decision block 320, if the system determines that the content item sentiment is positive, then the system continues at block 330, else the system jumps to block 380. In some embodiments, the system may be used to identify negative items instead of positive items, in which case this step can be reversed so that negative items continue and positive items are removed. For example, an organization could broadcast negative feedback on competitive products.

Continuing in block 330, the system determines whether the content item includes profanity or other offensive content. For example, the system may scan the content for keywords, look for known signatures of offensive content (e.g., an image checksum), and so forth. Even though content items reflect the views of users, an organization may not wish to be affiliated with profane or otherwise offensive content items. Continuing in decision block 340, if the system determines that the content item contains offensive content, then the system jumps to block 380, else the system continues at block 350.

Continuing in block 350, the system flags the content item for further review by a moderator. For example, the system may store content items in a database that includes state information for implementing a workflow through which content items are reviewed. As the item survives each step of moderation, the system flags the item for the next step in the workflow. The system may apply one or more automated processes of moderation to filter content items and reduce a number of content items that go through manual review. Continuing in block 360, the system receives a moderator review result that indicates whether a moderator determined that the content item is acceptable. The moderator may also provide additional information, such as metadata tags that identify a content category or other characteristics of the content item. The system may provide an interface through which moderators access content items pending review and indicate acceptance or rejection of each content item based on moderation criteria.

Continuing in decision block 370, if the moderation result indicates that the content item is acceptable, then the system continues at block 390, else the system jumps to block 380. If execution reaches block 380, the system indicates that the content item is unacceptable for publishing. For example, the system may delete the content item or flag the content item for batch deletion through a lazy content item cleanup process. Items may be unacceptable for publishing for a variety of reasons, such as due to content filtering, moderator opinion, and so forth. Continuing in block 390, the system flags the content item for publishing. A periodic publishing process identifies content items that are flagged for publishing and provides the flagged items in a feed or other publishing facility for consumers to receive the content items. After block 390, these steps conclude.

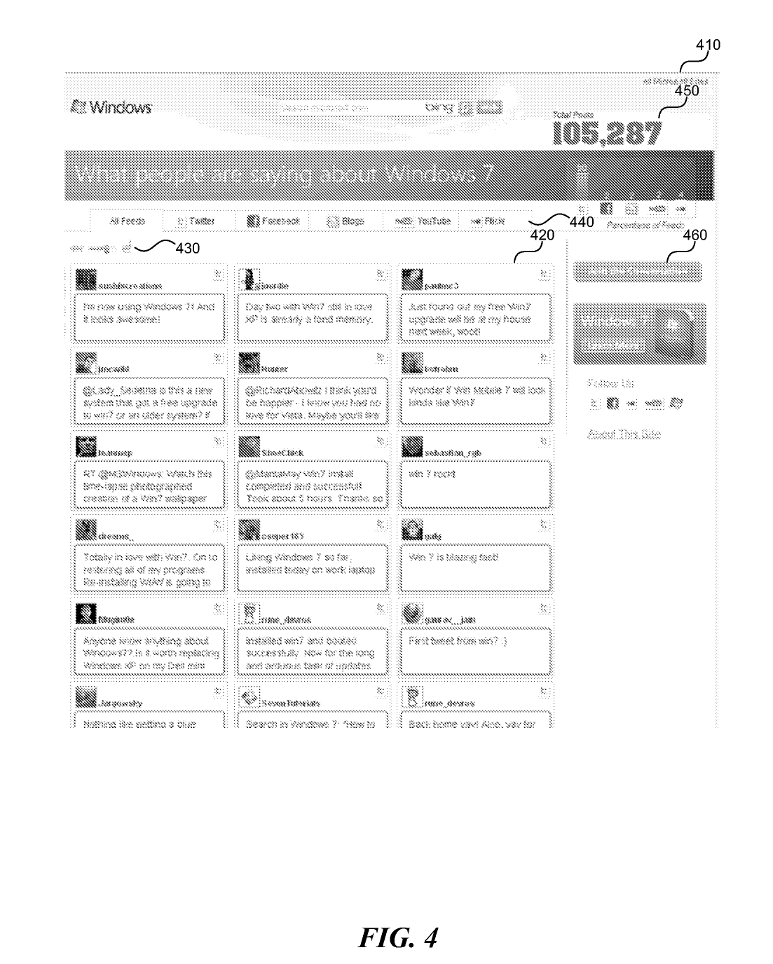

FIG. 4 is a display diagram that includes a display page that illustrates a page fed with data from the testimonial promotion system, in one embodiment. The display page 410 is a web page that includes a list of re-published content items such as content item 420. The list feeds new content items in from the top left at a regular rate (e.g., every second) and moves older items down. The display page 410 illustrates several other interactive elements that can be used with the system, such as a speed control 430, filter tabs 440, content item count 450, and content item submission control 460. The speed control 430 allows a user to speed up or slow down the rate at which new content items are added to the list. Depending on how fast a particular user can read the items, the user may change the speed to a rate most suitable for that user.

The filter tabs 440 allow the user to select a tab to view content items from a single content item source. Each content item 420 includes an icon in the upper right that indicates a source of the content item (e.g. twitter or a blog). The user may prefer content items from a particular source and can use the filter tabs 440 to select that source. The content item count 450 displays an increasing count of a number of content items published by the system. The count 450 provides an indication of the size of the conversation about a particular product. The content item submission control 460 allows a user to directly add a content item or to receive instructions for adding content items to sources monitored by the system. For example, selecting the control 460 may display a dialog that indicates a Twitter has tag or social network fan page that users can use when providing content items for the system to quickly identify the content items.

In some embodiments, the testimonial promotion system may receive user feedback about re-published content that further moderates or classifies the content. For example, the system may include a “Was this helpful?” link near each content item that a user can select to indicate that a content item was not helpful, was offensive, or other issues with the content item. The system can use a crowd-sourcing approach to accumulate statistics about user reactions to content items over time (e.g., short periods of 10-15 minutes or long periods of days or weeks) to determine further moderation actions for content items, such as removing a content item after a threshold number of users find it offensive or inapplicable. In addition, the system may bubble content items higher that are favored by users so that new users are more likely to see them even as additional content items continue to arrive.

In some embodiments, the testimonial promotion system provides a configurable speed control that allows users to select how often the system updates a display of content items. For example, a web page displaying a stream of positive blog posts or other content items may include a fast-to-slow slider bar that the user can click and slide to speed up or slow down an update rate of the display. The configuration may affect either a speed of processing items by the system for inclusion in a feed or a rate of retrieval by a user interface from the feed (or both).

In some embodiments, the testimonial promotion system provides a control through which a user can add the user's own opinion about a product or service of the organization or through which the user can inform the system about additional sources of content about the organization. For example, a user may be aware of a forum for discussing a product of the organization of which a maintainer of the system is unaware. By receiving a link or suggestion from the user, the maintainer may add the forum to a list of sources from which the system pulls content item data for display. Identified content items then go through the usual filtering and moderation phases described herein and are eligible for display in a published feed of the system. If the user adds a content item directly, such as his or her own review, then the system may directly store that content item in a data store of content items and moderate the content item for potential publishing.

In some embodiments, the testimonial promotion system displays other statistics in association with the published content items. For example, the system may include a total count of content items discovered to inform users of a level of interest of the world or a body of users in a particular product (e.g., 100,000 have taken the time to comment on the product). In addition, the system may display an indication of particular content sources that are most popular from which the system is receiving content items (e.g., if Facebook or Twitter posts are far more common than blog posts, then the system may display a bar graph or other visual indication of this statistic).

In some embodiments, the testimonial promotion system provides a link through which users can further publish a stream of product information to a user's own site. For example, the system may provide an RSS feed or other link to a stream of incoming product promotional information that a user can display on the user's own site. In some embodiments, the system allows the user to receive compensation for displaying the stream of promotional information (e.g., advertising revenue). The system may determine compensation based on a number of user impressions, clicks on content items, and so forth.

In some embodiments, the testimonial promotion system provides individual and aggregate feeds for sub-categories of organization information. For example, an organization like MICROSOFT™ may include a web page about MICROSOFT™ WINDOWS™ that includes positive testimonials about Windows, and another page that includes positive testimonials about other products, such as MICROSOFT™ Office. In addition, the organization may have a page that aggregates testimonials about multiple products, such as a home page of the organization.

In some embodiments, the testimonial promotion system dynamically animates newly published content items so that a displayed feed of content items slides new content items in. For example, a display of rows of content items may receive new content items that animate in from the top left and slide to the bottom right as new content items arrive. This allows users to feel a sense of the dynamic nature of ongoing conversations about an organization, and to follow a virtual pulse of buzz about a product or service.

In some embodiments, the testimonial promotion system displays advertisements in association with re-published content items. For example, upon receiving an indication that a user selected a content item to receive further details, the system may display the details of the content item as well as relevant advertising information. The advertising information may be targeted to the content to the content item. For example, if the content item says, “Windows 7 has great screen reading features,” then the advertisement may include promotion of accessibility features, such as, “We designed Windows 7 to be accessible to more users than ever!”

In some embodiments, the testimonial promotion system allows users to filter feeds based on filtering criteria. For example, if a feed includes content items from multiple sources, the system may allow the user to filter items to a single source, so that the user can see, for example, just Twitter posts. The system may also receive keywords or other filtering criteria from the user. For example, the user may want to see positive testimonials about a single feature of a product and may specify a keyword related to that feature to remove testimonials that do not mention that feature from the display.

From the foregoing, it will be appreciated that specific embodiments of the testimonial promotion system have been described herein for purposes of illustration, but that various modifications may be made without deviating from the spirit and scope of the invention. Accordingly, the invention is not limited except as by the appended claims.

I/We claim:

1. A computer-implemented method for automatically publishing user-generated promotional content providing testimonials about a product or service, the method comprising:
accessing configuration information that identifies one or more content sources from which to retrieve content items that potentially include testimonial information;
retrieving one or more content items from the configured content sources;
storing one or more retrieved content items in a data store;
moderating the retrieved content items to filter out content items that do not meet one or more publishing criteria; and
publishing content items that satisfy the publishing criteria,
wherein the preceding steps are performed by at least one processor.

2. The method of claim 1 wherein accessing configuration information comprises receiving a selection from an administrator of one or more sources from which to retrieve content items.

3. The method of claim 1 wherein accessing configuration information comprises receiving content item sources from one or more user suggestions.

4. The method of claim 1 wherein retrieving one or more content items comprises accessing a blog and retrieving a blog post or blog comment.

5. The method of claim 1 wherein retrieving one or more content items comprises accessing a third party data store such as a social network and retrieving a content entry.

6. The method of claim 1 wherein storing retrieved content items comprises storing metadata describing the content items, including a location from which each item was retrieved.

7. The method of claim 1 wherein moderating the retrieved content items comprises applying automated filtering rules to exclude profanity and content items with negative sentiment.

8. The method of claim 1 wherein moderating the retrieved content items comprises submitting content items to one or more moderators for manual review.

9. The method of claim 1 wherein moderating the retrieved content items comprises applying crowd-sourcing to allow users to identify items that satisfy publishing criteria.

10. The method of claim 1 wherein publishing content items comprises adding content items to a Really Simple Syndication (RSS) feed.

11. The method of claim 1 wherein publishing content items comprises publishing multiple categories of content items that each relates to a different product of the organization.

12. The method of claim 1 wherein publishing content items comprises publishing content items on a predetermined regular schedule and including any content items accepted through moderation since a last interval.

13. A computer system for automatic gathering and distribution of testimonial content, the system comprising:
a processor and memory configured to execute software instructions;
a content acquisition component configured to search a network for one or more content sources and identify content potentially related to an organization;
a content data store configured to store identified content for further review and potential re-publishing;
a content filtering component configured to automatically review and filter identified content to eliminate content that does not satisfy one or more publishing criteria;
a content moderation component configured to receive indications from human moderators that indicate whether particular content items are suitable for publishing; and
a content publishing component configured to provide one or more streams of content items that satisfy publishing criteria and moderation and promote products or services of the organization.

14. The system of claim 13 wherein the content acquisition component is further configured to store information about identified content in the content data store, wherein the stored information includes a link to the original content.

15. The system of claim 13 wherein the content filtering component is further configured to employ keyword filters to eliminate content items that include profanity or negative sentiment.

16. The system of claim 13 wherein the content filtering component is further configured categorize content for subsequent publishing by category.

17. The system of claim 13 wherein the content filtering component is further configured to apply results of human moderation to provide a feedback loop that improves automated moderation over time.

18. The system of claim 13 wherein the content publishing component is further configured to place content to be published on a queue and at a configurable interval read the queues and publish content items in a feed.

19. A computer-readable storage medium comprising instructions for controlling a computer system to moderate promotional content, wherein the instructions, when executed, cause a processor to perform actions comprising:
identifying content sentiment that indicates a tone and purpose of a content item;
determining whether the content item includes offensive content;
flagging the content item for further review by a moderator;
receiving a moderator review result that indicates whether a moderator determined that the content item is acceptable for publishing;
upon determining that the content item includes a negative sentiment, includes offensive content, or was unacceptable for publishing, flagging the content item for deletion from a data store; and
upon determining that the content item is acceptable for publishing, flagging the content item for publishing.

20. The medium of claim 19 further comprising, receiving a request to identify content items ready for publishing and providing one or more content items flagged for publishing in response.
